(19) United States
(12) Patent Application Publication
(10) Pub. No.: US 2017/0255960 A1
(43) Pub. Date: Sep. 7, 2017

(54) System and Method for Enhanced and Specifically Targeted Saturation Mailing of a Plurality of Client Target Printed Communications and Publications

(71) Applicant: Trend Offset Printing Services, Inc., Los Alamitos, CA (US)

(72) Inventors: Aaron Edward Day, Los Alamitos, CA (US); Joe Cha, Los Alamitos, CA (US)

(73) Assignee: Trend Offset Printing Services, Inc., Los Alamitos, CA (US)

(21) Appl. No.: 15/058,419

(22) Filed: Mar. 2, 2016

(51) Int. Cl. G06Q 30/02

(52) U.S. Cl. CPC G06Q 30/0251

(57) ABSTRACT

Systems and methods for enhanced and targeted saturation or high density mailing of a plurality of client target publications to a plurality of recipients, as disclosed, include: a first host publication; at least one insert printed communication; a first client target publication version, comprising the first host publication and at least one insert printed communication; a second client target publication version, comprising the first host publication and at least one insert printed communication, wherein the first client target publication version and the second client target publication version comprise a different set of insert printed communications; at least one mailing list, wherein the mailing list comprises mailing addresses from at least one delivery zone, at least one zip code or a combination thereof; a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version; and wherein the first client target publication or the second client target publication does not exceed a prescribed mailing weight, mail rate or combination thereof.

### FIELD OF THE SUBJECT MATTER

The field of the subject matter is enhanced and specifically targeted saturation mailing of a plurality of client target printed communications.

### BACKGROUND

Combined mailer systems or “co-mail” systems are generally systems that merge and bind or group multiple titles or printed communications to take advantage of bulk rates or lower rates provided by the United States Postal Service or USPS for the combining of multiple titles, as opposed to a single title. For example, the USPS may have a specific rate for a specific weight, and a Time® magazine being delivered to a house may be under that specific weight—but is going to be charged the rate nonetheless. Therefore, a company may combine that Time® magazine with a Lands End® catalog and a GQ® magazine—also going to the same address—in order to take advantage of the single specific rate. They are then placed on a pallet with other co-mail printed communications and sent to a particular USPS branch location.

There are several problems associated with co-mailing. First, a co-mailing company may hold a person's subscription publications for several days until the weight requirement or limit is met. Second, a co-mailing company uses extraneous material to “bind” the co-mailed bundle, which may be a strap or poly/plastic bag. Many locales, such as San Francisco, have or are banning the use of plastic bags. In addition, many consumers do not want to dispose of additional waste, such as straps, that cannot be recycled.

There have been a number of systems that try to improve the process. As an example, U.S. Pat. No. 7,221,996, issued to Donald Benson, discloses a system for co-mailing a group of diverse publications, such as magazines, catalogues and other “subscription” publications. This patent describes a system that orders a publication at the bindery into a specific order for the co-mailer, wherein the co-mailer can merge this specific order of Publication A with another specific order of Publication B until the weight maximum is met. The difference between the system disclosed in the '996 patent and traditional or conventional co-mailing is that in the '996 patent, they do not contemplate using generic titles or publications in their process.

While co-mailing is a relatively mature process, a newer category of mail has been defined by the USPS: high density or “saturation” letters, printed communications or mail. The USPS defines this type of mail as follows: “Meet(s) the density requirement of at least 90% or more of the active residential addresses or 75% or more of the total number of active possible delivery addresses on each carrier route receiving this mail. . . . Multiple pieces per delivery address do not count toward this density standard.” Saturation mail must also “be prepared in walk sequence according to the schemes prescribed by the USPS”, which means that it must be in carrier route order. (See http://pe.usps.com/text/dmm300/243.htm) Saturation mail, when it meets the USPS requirements, is given a discounted rate that goes beyond a bulk rate mailing price, depending on the weight of the piece of mail.

To this end, it would be desirable to use saturation or high density mail as a host to carry specific and subscriber or “list driven” passenger printed communications in order to take advantage of the lower mailing rate. It would also be desirable to be able to manage this process so that companies who have printed communications that are mailed out using an address list and that need to be mailed out on schedule are able to reliably tag along with saturation mail on a specific schedule. It would also be ideal to be able to ensure that the USPS process is as efficient as possible, by providing the saturation mail bundle in an ordered and addressed form, so that the carriers can easily distribute this mail on their routes.

### SUMMARY OF THE SUBJECT MATTER

Systems and methods for enhanced and targeted saturation or high density mailing of a plurality of client target printed communications to a plurality of recipients, as disclosed, include: a first host publication; at least one insert printed communication; a first client target publication version, comprising the first host publication and at least one insert printed communication; a second client target publication version, comprising the first host publication and at least one insert printed communication, wherein the first client target publication version and the second client target publication version comprise a different set of insert printed communications; at least one mailing list, wherein the mailing list comprises mailing addresses from at least one delivery zone, at least one zip code or a combination thereof; a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version; and wherein the first client target publication or the second client target publication does not exceed a prescribed mailing weight, mail rate or combination thereof.

A method for enhanced and targeted saturation or high density mailing of a plurality of client target printed communications to a plurality of recipients includes: providing a first host publication; providing at least one insert printed communication; providing a first client target publication version, comprising the first host publication and at least one insert printed communication; producing a second client target publication version, comprising the first host publication and at least one insert printed communication, wherein the first client target publication version and the second client target publication version comprise a different set of insert printed communications; providing at least one mailing list, wherein the mailing list comprises mailing addresses from at least one delivery zone, at least one zip code or a combination thereof; implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version; and wherein the first client target publication or the second client target publication does not exceed a prescribed mailing weight, mail rate or combination thereof.

A computer-implemented method for enhanced and targeted saturation or high density mailing of a plurality of client target publications to a plurality of recipients, is contemplated and includes: providing a first host publication; providing at least one insert printed communication; producing a first client target publication version, comprising the first host publication and at least one insert printed communication; producing a second client target publication version, comprising the first host publication and at least one insert printed communication, wherein the first client target publication version and the second client target publication version comprise a different set of insert printed communications; providing at least one mailing list, wherein the mailing list comprises mailing addresses from at least one delivery zone, at least one zip code or a combination thereof; implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version; and wherein the first client target publication or the second client target publication does not exceed a prescribed mailing weight, mail rate or combination thereof, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof.

A computer-implemented executable software application is contemplated herein that implements the methods disclosed, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof.

### BRIEF DESCRIPTION OF THE FIGURES

FIG. 1 shows a contemplated system embodiment.

FIG. 2 shows a contemplated method embodiment.

FIG. 3 shows a contemplated computer-implemented executable software embodiment.

FIG. 4 shows a contemplated process flow chart for a contemplated method embodiment.

### DETAILED DESCRIPTION

A system and method had been developed where saturation or high density mail can be used as a host to carry specific and subscriber or “list driven” passenger printed communications in order to take advantage of the lower mailing rate. Contemplated systems and methods are able to manage this process so that companies who have printed communications that are mailed out using an address list and that need to be mailed out on schedule are able to reliably tag along with saturation mail on a specific schedule. Contemplated systems and methods ensure that the USPS process is as efficient as possible, by providing the saturation mail bundle in an ordered and addressed form, so that the carriers can easily distribute this mail on their routes.

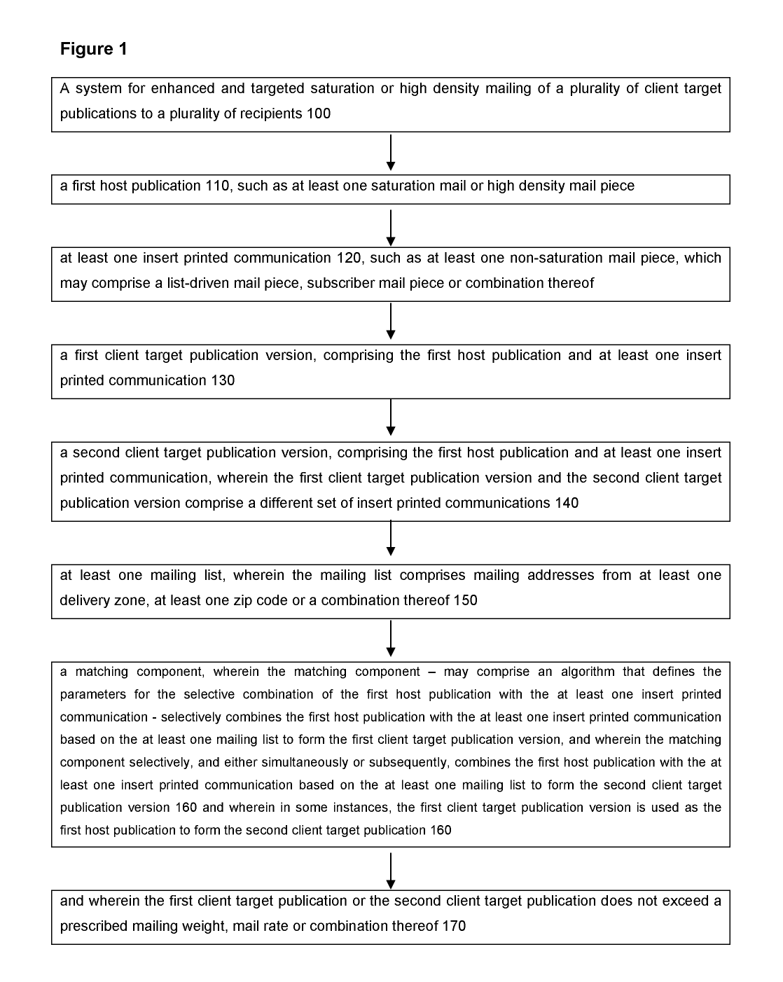

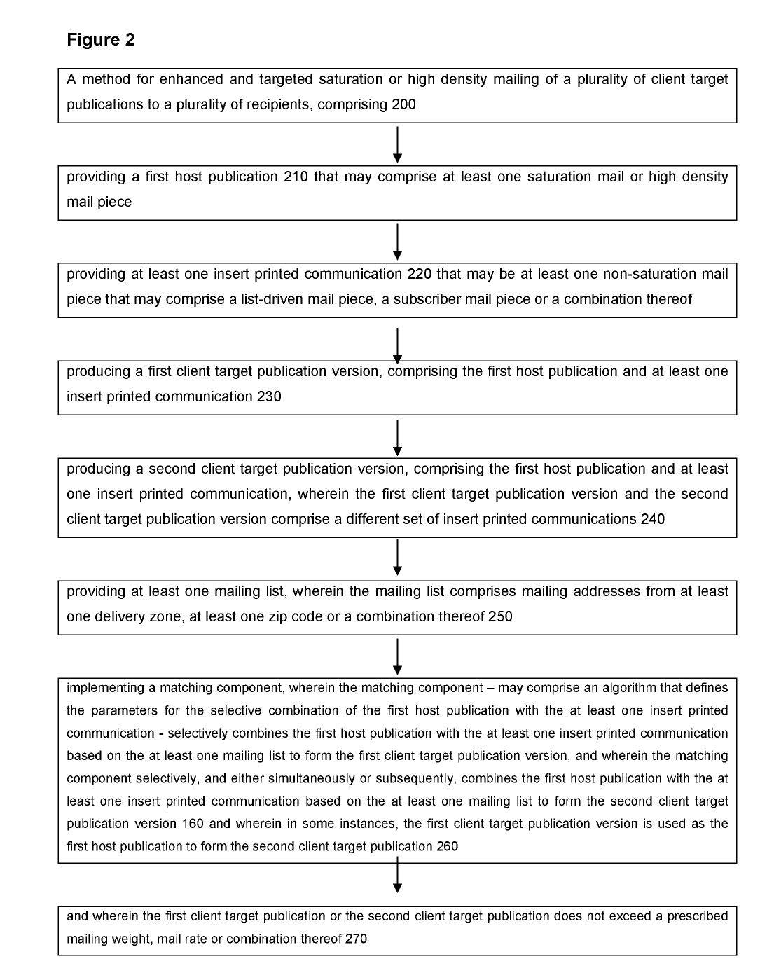

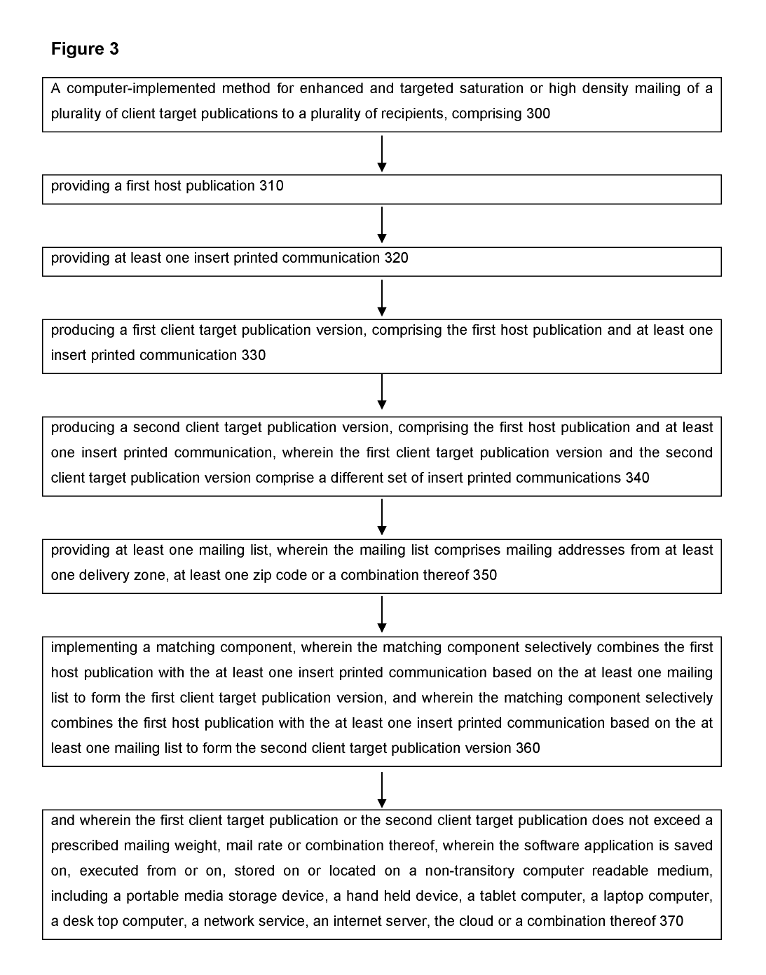

Systems, as shown in FIG. 1, and methods, as shown in FIGS. 2 and 3, for enhanced and targeted saturation mailing of a plurality of client target publications to a plurality of recipients 100, as disclosed, include: a first host publication 110; at least one insert printed communication 120; a first client target publication version, comprising the first host publication and at least one insert printed communication 130; a second client target publication version, comprising the first host publication and at least one insert printed communication, wherein the first client target publication version and the second client target publication version comprise a different set of insert printed communications 140; at least one mailing list, wherein the mailing list comprises mailing addresses from at least one delivery zone, at least one zip code or a combination thereof 150; a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version 160; and wherein the first client target publication or the second client target publication does not exceed a prescribed mailing weight, mail rate or combination thereof 170.

A method for enhanced and targeted saturation or high density mailing of a plurality of client target printed communications to a plurality of recipients 200, as disclosed is shown in FIG. 2, and includes: providing a first host publication 210; providing at least one insert printed communication 220; providing a first client target publication version, comprising the first host publication and at least one insert printed communication 230; producing a second client target publication version, comprising the first host publication and at least one insert printed communication, wherein the first client target publication version and the second client target publication version comprise a different set of insert printed communications 240; providing at least one mailing list, wherein the mailing list comprises mailing addresses from at least one delivery zone, at least one zip code or a combination thereof 250; implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version 260; and wherein the first client target publication or the second client target publication does not exceed a prescribed mailing weight, mail rate or combination thereof 270.

As used herein, the phrase “first host publication” generally refers to those publications that are considered suitable as a saturation mail or high density mail publication or mailing. In some embodiments, a contemplated first host publication may comprise a store circular, a coupon or discount publication, a local newspaper circular that is delivered to all homes in an area, a grocery store circular or any other publication that is designed to meet the USPS requirements for “saturation” or high density mail. The USPS defines this type of mail as follows: “Meet(s) the density requirement of at least 90% or more of the active residential addresses or 75% or more of the total number of active possible delivery addresses on each carrier route receiving this mail. Multiple pieces per delivery address do not count toward this density standard.” Saturation mail must also “be prepared in walk sequence according to the schemes prescribed by the USPS”, which means that it must be in carrier route order. In other contemplated embodiments, first host publications are those that are non-subscription mail.

As used herein, the phrase “at least one insert printed communication” means that or those printed communications that are not defined under the definition of “saturation” or high density mail by the USPS. These contemplated printed communications are targeted, in some way, at a specific audience, whether it is subscribers, streets, zip codes, key demographic areas, etc. As contemplated herein, “at least one” means that there may be one insert printed communication or more than one insert printed communication, where when there is more than one—it is understood that they may be different from one another and yet targeted to the same person, household or business.

In contemplated embodiments, a first client target publication version is produced that comprises the first host publication and at least one insert printed communication, as disclosed herein. A second client target publication version may also be produced that comprises the first host publication and at least one insert printed communication, wherein the first client target publication version and the second client target publication version comprise a different set of insert printed communications. A client target publication is contemplated to be a combination, as disclosed above, that is specifically developed for a home, individual or business. It is understood that the “host” or basis for a contemplated client target publication is a high density or saturation mail publication. It is also understood that the “passenger” or “passengers” are one or more insert printed communications that are list-driven printed communications.

In contemplated embodiments, a matching component is provided, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version; and wherein the first client target publication or the second client target publication does not exceed a prescribed mailing weight, mail rate or combination thereof. It should be understood that the matching component may also selectively combine host publications and insert printed communications to form third, fourth, fifth or more client target publication versions.

In some contemplated embodiments, the matching component selectively and simultaneously combines the first host publication with the at least one insert printed communication based on the at least one mailing list to form the first client target publication version, and selectively and simultaneously combines the first host publication with the at least one insert printed communication based on the at least one mailing list to form the second client target publication version.

In other contemplated embodiments, the matching component selectively combines the first host publication with the at least one insert printed communication based on the at least one mailing list to form the first client target publication version, and selectively and subsequently combines the first host publication with the at least one insert printed communication based on the at least one mailing list to form the second client target publication version, wherein the first client target publication version is used as the first host publication to form the second client target publication.

In some embodiments, a contemplated matching component comprises an algorithm that defines the parameters for the selective combination of the first (or additional) host publication(s) with the at least one insert printed communication. A contemplated algorithm may also be included as part of a broader and more complex software package that is designed to implement the methods disclosed herein, including capturing and intelligently sorting at least one mailing list, wherein the mailing list comprises mailing addresses from at least one delivery zone, at least one zip code or a combination thereof, capturing the first host publication, capturing the at least one insert printed communication(s), guiding the production of the first client target publication, the second client target publication and additional client target publications.

It should be noted that the software contemplated herein is not replacing a process that has traditionally been done manually—in other words, merely automating a process. This software and algorithm is providing a service that was otherwise unavailable in a relatively new area of mail production and management—saturation and high density mail.

A computer-implemented method for enhanced and targeted saturation or high density mailing of a plurality of client target publications to a plurality of recipients 300, is contemplated, shown in FIG. 3 and includes: providing a first host publication 310; providing at least one insert printed communication 320; producing a first client target publication version, comprising the first host publication and at least one insert printed communication 330; producing a second client target publication version, comprising the first host publication and at least one insert printed communication, wherein the first client target publication version and the second client target publication version comprise a different set of insert printed communications 340; providing at least one mailing list, wherein the mailing list comprises mailing addresses from at least one delivery zone, at least one zip code or a combination thereof 350; implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version 360; and wherein the first client target publication or the second client target publication does not exceed a prescribed mailing weight, mail rate or combination thereof, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof 370.

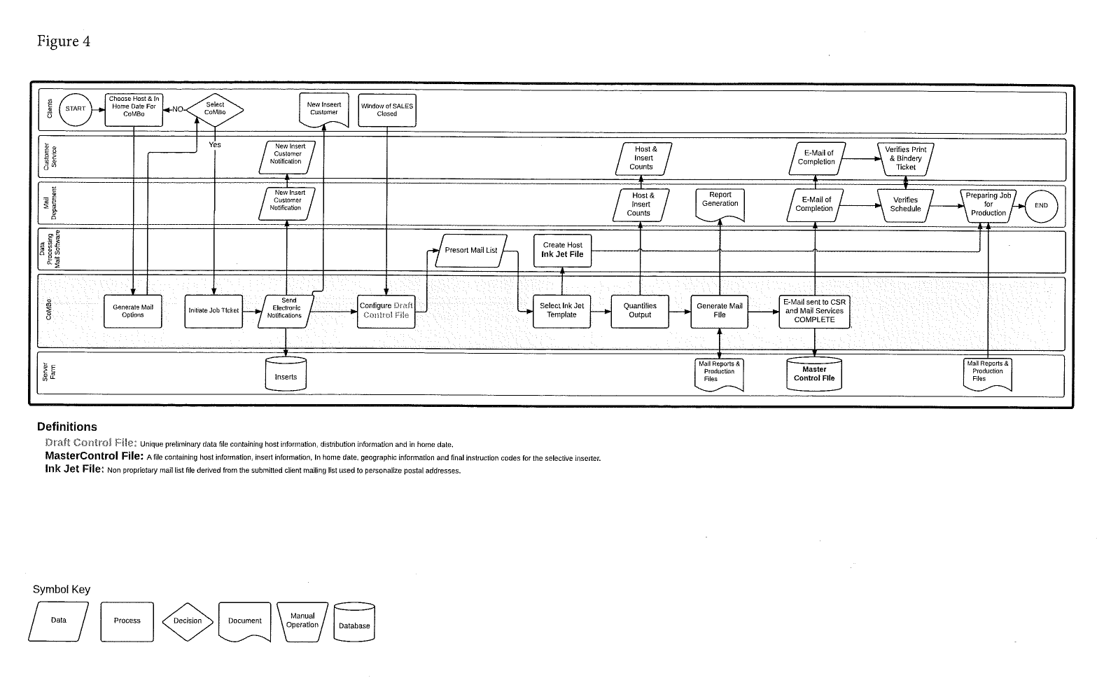

A computer-implemented executable software application is contemplated herein and is generally shown in FIG. 4 that implements the methods disclosed, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof. In some contemplated embodiments, the computer-implemented executable software application is accessed by utilizing a web-based portal or interface that is located at a specific uniform resource locator or URL, which is an address to a resource on the Internet.

As described herein, a system and method had been developed where saturation or high density mail can be used as a host to carry specific and subscriber or “list driven” passenger printed communications in order to take advantage of the lower mailing rate. Contemplated systems and methods are able to manage this process so that companies who have printed communications that are mailed out using an address list and that need to be mailed out on schedule are able to reliably tag along with saturation mail on a specific schedule. Contemplated systems and methods ensure that the USPS process is as efficient as possible, by providing the saturation mail bundle in an ordered and addressed form, so that the carriers can easily distribute this mail on their routes.

In addition, contemplated systems and methods are able to catalog and track a number of different saturation mail pieces, what days they are delivered and their long term print schedule. But what elevates contemplated systems and methods above any conventional systems or methods is the ability to interface with clients who have printed communications that are mail list driven or list driven, such that they are satisfied with the ability produce their printed communications and have them reliably and predictably “tag along” with saturation mail pieces or publications. In addition, any number of insert printed communications can be coupled with any number of saturation mail hosts on different days of the week or month, so that these list-driven inserts don't need to be held until a particular maximum weight for the mail rate is reached. Contemplated systems can also shift inserts from one piece of host mail to another, if it would help to balance out the weight of the total piece, such that the maximum weight for the mail rate isn't exceeded.

### EXAMPLES

### Example 1

Introduction

This example describes the flow of a host and insert from the time the Mail Department begins processing them to the time they are physically taken to a post office facility for mailing. For purposes of this example, a host is typically a flat magazine or circular, and an insert is typically a single sheet piece of advertising that is physically inserted into the host by a machine known as a selective inserter.

The steps in this example illustrate the flow. The format of this document is as follows:

Function: what is the purpose of the step

Actor: who is involved in the step

Example: an example of the step

Software: software that is used in the step

Schedule the Host and Insert Mailing/Job Start

Function: Schedule the actual time a host and insert will be mailed to the recipients

Actor: Customer Service Representatives (CSR)

Example: The HTV job is scheduled to be delivered the week of Dec. 26, 2015. This includes the counts of the hosts and the inserts. The host and inserts weights and sizes are known to a good level of certainty at this point.

Software: Prograph is currently used by the CSRs

Touch point with another step: The schedule is subject to change depending on the client, availability of press, and so on. For example, the customer may decide to add more pages to a printed communication at the last minute. This will potentially affect all the other steps in the flow.

Commentary: For the December mailing, HTV has its own inserts, which is not typical. When a schedule changes, Prograph will be updated to reflect the change alerts will be issued.

The client with the inserts decides which host they want to use and when, and the info will be very complete before Mail.dat(s) is constructed (that is, before the Presort step. Mail.dat is at the “end of the line”, it is what “has already happened” The Mail.dat files are for historical analysis). At this point the mail team will have the weights, and when and where the items are being mailed. The mail team has the address list down to the address, and a report.

Obtain and Modify the Host Address List

Function: Obtain mailing list

### Actor: Mail Department

Example: A mailing list for Utah is rented for 90 days
Software: Touch point with another step:
Commentary: The addresses (e.g., 500,000 in the case of the HTV host) is obtained from a third party address provider by the Mail Department. This is the list that drives where the host is mailed. The address list is licensed for approximately 90 days, after which it needs to be updated. The updates are typically not extensive. For HTV, the list is split into 12 major zones resulting in 12 books. (One composite file with indicator to show “split point”, that is, which version. Using BCC currently, any DBMS can be used.) Secondary fields describe, inserts, and Detached Address Label (DAL) cards.

The addresses include the zip code and carrier route. When DALs are used, carrier route is important. The finest point is down to the individual address. If the contemplated software UI is presenting a map, it needs to be concerned with carrier routes on the map. If the host or insert is already mailing to an area, and asking the question: “can we use this overlap?”, then a file will be uploaded a file. A report is generated with weights and counts.

Acquire the Client's Insert Data

Function: This describes what the inserts are and which host(s) they are inserted into

### Actor: Mail Department

Example: HTV provides a spreadsheet; a portion is shown below
Software: Excel or other spreadsheet software
Touch point with another step: the spreadsheet is manipulated in the next step, Perform Manual Versioning of Client's Insert Information.
Commentary: HTV supplies a spreadsheet that lists the inserts and delivery zones and zip codes.

A “version” is specific combination of host and insert. For the December mailing, there are approximately 15 HTV hosts, each with some combination of inserts, for a total of approximately 60 versions. Versions can have different weights (imagine an 8 oz. host with a ⅛ oz. insert, versus a 10 oz. host with 6 separate ⅛ oz. inserts, thus the weight of the former is 8.125 oz., and the weight of the latter is 10.75 oz.)

Zones are determined by client, HTV in this case.

Here is an example from the spreadsheet of a host with 6 inserts in a comma separated list:

16 oz. is the maximum weight for combined host and inserts; this max weight is a parameter that can be obtained from a database (in the event it changes in the future, we don't want to hard-code that into contemplated software).

Perform Manual Versioning of Client's Insert Information

Function: A manual step is performed to manipulate the spreadsheet so the inserts are no longer in a comma-separated list but are assigned to a location in the selective inserter

### Actor: Mail Department

Example: a portion of the spreadsheet is shown below
Software: Excel or other spreadsheet software
Touch point with another step: this is the spreadsheet obtained originally from the previous step, Acquire the client's insert data.

### Commentary:

Here is an example of the spreadsheet after manual versioning:
In this example, insert BIC1215LSV1 is in the first inserter location, and so on.

Get Customer Approval

Function The customer approves of the finalized spreadsheet verifying counts, zip codes, and DMLs.

### Actor: Mail Department

Software: Excel or other spreadsheet software
Touch point with another step: this is the spreadsheet obtained originally from the previous step, Perform Manual Versioning of the Client's Insert Information.

Future Runs

Function: the selective inserter physically puts the insert into the host
Example: see below
Commentary: To run multiple versions simultaneously, the selective inserter is doing the work. This was referred to as a “phantom box” during the meeting, hence the dashed lines box representing the step on page 1.
For Example, suppose we had an HTV host with one insert:

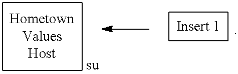

And suppose we had the same HTV host with two inserts:

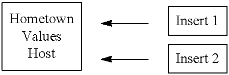

Both inserts can be placed in the selective inserter and the selective inserter will make two runs. For the first run only insert one is inserted into the host; for the second run, both inserts are inserted.

Presort Each Version

Function: Generate the Mail.dat file(s)

### Actor: Mail Department

Software: BCC software (http://bccsoftware.com/tech-tip-using-impb/)
Commentary: Repeating what is on page 3, this step is at the “end of the line”, it is what “has already happened”. From a standpoint of the contemplated software, the Mail.dat extracted text files (.hdr, .pqt, etc.) are for historical analysis. The unique combination of “DAL card/short cover/set of inserts” is a separate run and version.

Take Items to Post Office Mail Facility

Function: Get the mail to a location from where it will be delivered

Glossary

CSR Customer Service Representatives, Trend Offset Printing personnel that work with customers
DAL Detached Advertising Label, United States Postal Service term for a label similar to a (Detached Mailing Label) DML, but contains advertising

### DBMS Database Management System

DML Detached Mailing Label, a United States Postal Service term for an address label that is physically detached from the item being mailed and is added to a piece of mail by the carrier at the time the item is deposited in a recipient's mailbox
DMM Domestic Mail Manual, a United States Postal Service manual
HTV Hometown Values, a publication based in West Valley City Utah

### Example 2

FIG. 4 shows another overall process flow chart that describes and illustrates a contemplated embodiment, including providing another option to the process disclosed in Example 1. In this Example, a key portion of the contemplated embodiments are referred to as “CoMBo”.

In this process, the client chooses the host publication and date for the insert publication to arrive at the home of the intended recipient. Mail options are generated by the CoMBo system and the client is given those options to consider and select. If the client moves forward with the process, a job ticket is initiated and the client receives a number of electronic notifications, including information as to how to provide the insert publication(s), address list and other necessary items, if needed. A new insert customer notification is then sent by the system to the mail department and the customer service department in order to keep them in the loop.

Once all of the inserts, mail lists and additional information is received, the “window of sales” is closed for the client and the system starts processing the final publication that gets mailed out to the recipients. The mail list is presorted, an ink jet template is selected and an ink jet file is created for the host publication. The system quantifies the output and host publication and insert publication counts are sent to the mail department and the customer service departments. A mail file is generated by the system and various reports are generated for the mail department and for the server system.

An E-mail is generated and sent to the mail department and the customer service department. The master control file is then sent to the server. The departments verify the print and bindery ticket and the schedule. The job is prepared for production. Once the job is finalized and the publications sent, various production reports and files are sent to and/or saved on the server.

Thus, specific embodiments, methods of enhanced and specifically targeted saturation or high density mailing of a plurality of client target publications have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A system for enhanced and targeted saturation or high density mailing of a plurality of client target publications to a plurality of recipients, comprising:
a first host publication;
at least one insert printed communication;
a first client target publication version, comprising the first host publication and at least one insert printed communication;
a second client target publication version, comprising the first host publication and at least one insert printed communication, wherein the first client target publication version and the second client target publication version comprise a different set of insert printed communications;
at least one mailing list, wherein the mailing list comprises mailing addresses from at least one delivery zone, at least one zip code or a combination thereof;
a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version;
and wherein the first client target publication or the second client target publication does not exceed a prescribed mailing weight, mail rate or combination thereof.

2. The system of claim 1, wherein the first host publication comprises at least one saturation mail or high density mail piece.

3. The system of claim 1, wherein the at least one insert printed communication is at least one non-saturation mail piece.

4. The system of claim 3, wherein the at least one non-saturation mail piece comprises list-driven mail piece, subscriber mail piece or combination thereof.

5. The system of claim 1, wherein the matching component selectively and simultaneously combines the first host publication with the at least one insert printed communication based on the at least one mailing list to form the first client target publication version, and selectively and simultaneously combines the first host publication with the at least one insert printed communication based on the at least one mailing list to form the second client target publication version.

6. The system of claim 1, wherein the matching component selectively combines the first host publication with the at least one insert printed communication based on the at least one mailing list to form the first client target publication version, and selectively and subsequently combines the first host publication with the at least one insert printed communication based on the at least one mailing list to form the second client target publication version, wherein the first client target publication version is used as the first host publication to form the second client target publication.

7. The system of claim 1, wherein the matching component comprises an algorithm that defines the parameters for the selective combination of the first host publication with the at least one insert printed communication.

8. A method for enhanced and targeted saturation or high density mailing of a plurality of client target publications to a plurality of recipients, comprising:
providing a first host publication;
providing at least one insert printed communication;
producing a first client target publication version, comprising the first host publication and at least one insert printed communication; producing a second client target publication version, comprising the first host publication and at least one insert printed communication, wherein the first client target publication version and the second client target publication version comprise a different set of insert printed communications;
providing at least one mailing list, wherein the mailing list comprises mailing addresses from at least one delivery zone, at least one zip code or a combination thereof;
implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version;
and wherein the first client target publication or the second client target publication does not exceed a prescribed mailing weight, mail rate or combination thereof.

9. The method of claim 8, wherein the matching component selectively and simultaneously combines the first host publication with the at least one insert printed communication based on the at least one mailing list to form the first client target publication version, and selectively and simultaneously combines the first host publication with the at least one insert printed communication based on the at least one mailing list to form the second client target publication version.

10. The method of claim 8, wherein the matching component selectively combines the first host publication with the at least one insert printed communication based on the at least one mailing list to form the first client target publication version, and selectively and subsequently combines the first host publication with the at least one insert printed communication based on the at least one mailing list to form the second client target publication version, wherein the first client target publication version is used as the first host publication to form the second client target publication.

11. The method of claim 8, wherein the first host publication comprises at least one saturation mail or high density mail piece.

12. The method of claim 8, wherein the at least one insert printed communication is at least one non-saturation mail piece.

13. The method of claim 12, wherein the at least one non-saturation mail piece comprises list-driven mail piece, subscriber mail piece or combination thereof.

14. A computer-implemented executable software application that implements the method of claim 8, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof.

15. A computer-implemented method for enhanced and targeted saturation or high density mailing of a plurality of client target publications to a plurality of recipients, comprising:
providing a first host publication;
providing at least one insert printed communication;
producing a first client target publication version, comprising the first host publication and at least one insert printed communication;
producing a second client target publication version, comprising the first host publication and at least one insert printed communication, wherein the first client target publication version and the second client target publication version comprise a different set of insert printed communications;
providing at least one mailing list, wherein the mailing list comprises mailing addresses from at least one delivery zone, at least one zip code or a combination thereof;
implementing a matching component, wherein the matching component selectively combines the first host publication with the at least one insert printed communication based on the at least one mailing list to form the first client target publication version, and wherein the matching component selectively combines the first host publication with the at least one insert printed communication based on the at least one mailing list to form the second client target publication version;
and wherein the first client target publication or the second client target publication does not exceed a prescribed mailing weight, mail rate or combination thereof, wherein the software application is saved on, executed from or on, stored on or located on a non-transitory computer readable medium, including a portable media storage device, a hand held device, a tablet computer, a laptop computer, a desk top computer, a network service, an internet server, the cloud or a combination thereof.
